(19) United States
(12) Patent Application Publication
(10) Pub. No.: US 2009/0303152 A1
(43) Pub. Date: Dec. 10, 2009

(54) ANTENNA APPARATUS

(75) Inventors: Akira Takaoka, Okazaki-city (JP); Noriaki Okada, Chiryu-city (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/478,115

(22) Filed: Jun. 4, 2009

(30) Foreign Application Priority Data
Jun. 4, 2008 (JP) 2008-147340

(51) Int. Cl. H01Q 1/36; H01Q 1/38

(52) U.S. Cl. 343/895; 343/700 MS

(57) ABSTRACT

An antenna apparatus includes an antenna and a support member. The antenna has (i) an outer element, which has a spiral section prolonged spirally in an axial direction, and (ii) an inner element, which has a spiral section prolonged spirally in the axial direction and is surrounded with an interval space by the outer element. The antenna is a terminal open type in which one of the two elements is used as a signal line and the other is used as a GND line. The support member includes a dielectric member and contacts each of the spiral sections of the outer and inner elements while supporting the outer and inner elements in a predetermined positional relationship. Further, the number of turns of the spiral section in the inner element is equal to or less than the number of turns of the spiral section in the outer element.

### CROSS REFERENCE TO RELATED APPLICATION

The present application is based on and incorporates herein by reference Japanese Patent Application No. 2008-147340 filed on Jun. 4, 2008.

### FIELD OF THE INVENTION

The present invention relates to an antenna apparatus for a keyless remote system or smart entry system in a vehicle or residence.

### BACKGROUND OF THE INVENTION

Patent document 1: JP-2003-152427 A

Patent document 2: JP 2007-43653 A (corresponding to US2006/0290590)

Patent document 3: JP 2008-227862 A (corresponding to US2008/0224945)

A wireless apparatus as an antenna apparatus for a home-use or vehicle-use keyless remote system (i.e., a so-called keyless receiver) uses a radio wave (UHF or VHF band) having a comparatively long wavelength (tens of centimeters to several meters). The size or dimensions of an antenna is dominant to the physique or dimensions of the antenna apparatus. Therefore, it is important to miniaturize the antenna to miniaturize antenna apparatus.

In contrast, Patent document 1 describes a configuration which miniaturizes an antenna as follows. The antenna has an inner conductor linearly prolonged, and an outer conductor, which is spaced from the linear inner conductor and is densely spirally prolonged with the linear inner conductor centered, and resonates at a specific frequency.

The above configuration may restrict miniaturization of the antenna apparatus since the inner conductor is prolonged in the shape of a straight line. For example, in miniaturizing a wireless apparatus, when reducing the dimension of the antenna in the direction orthogonal to the prolonged direction of the inner conductor, at least one of the linear inner conductor or coil-shaped outer conductor needs to be lengthened to maintain an electric length for resonance. Since the inner conductor is linear, the height of the antenna naturally increases greatly.

To that end, the Applicant proposes, in Patent document 2, a terminal open type antenna as follows. The antenna includes two elements functioning respectively as a signal line and a GND line. Of the two elements, an outer element prolonged spirally in an axial direction surrounds, with an interval space, an inner element prolonged spirally in the axial direction. When the inner element is thus made spiral, the frequency band can be narrowed to thereby improve an antenna gain. Such an antenna can reduce the physique or dimensions compared with the antenna having a linear inner element if the comparable antenna gain is required.

In addition, the Applicant proposes, in Patent document 3, an antenna apparatus in which the above antenna is maintained in a predetermined positional relationship using a support member made of dielectrics. According to such an antenna apparatus, while the two elements are held in the predetermined positional relationship using the support member, the performance of the antenna can be maintained. Further, the physique of the antenna apparatus can be miniaturized according to the effect of shortening the wavelength of the high frequency current by the dielectrics.

Herein, the present Inventors confirmed that when the support member made of the dielectrics is adopted, the relationship between the numbers of turns of the spirals in the two elements affects the antenna gain (i.e., the physique of the antenna).

### SUMMARY OF THE INVENTION

It is an object to provide an antenna apparatus for miniaturizing the physique of an antenna more effectively while maintaining a performance of the antenna.

According to an example of the present invention, an antenna apparatus is provided as follows. An antenna and a support member are included. The antenna is a terminal open type including (i) an outer element, which has a spiral section prolonged spirally in an axial direction, and (ii) an inner element, which has a spiral section prolonged spirally in the axial direction and is surrounded, with an interval space, by the outer element. One of the two elements is a signal line, the other of the two elements is a GND line. The support member includes a dielectric member and contacting each of the spiral sections of the outer and inner elements while supporting the outer and inner elements in a predetermined positional relationship. Herein, a number of turns of the spiral section in the inner element is equal to or less than a number of turns of the spiral section in the outer element.

### BRIEF DESCRIPTION OF THE DRAWINGS

The above and other objects, features, and advantages of the present invention will become more apparent from the following detailed description made with reference to the accompanying drawings. In the drawings:

FIG. 1 is a plan view illustrating an outline configuration of a main part of an antenna apparatus according to a first embodiment of the present invention;

FIG. 2 is a perspective view illustrating a periphery of an antenna in FIG. 1;

FIG. 3 is a perspective view virtually transparently illustrating an inner element of the antenna in FIG. 2;

FIG. 4 is a perspective view illustrating an outline configuration of a lead frame which constitutes a lower part of an outer element;

FIG. 5 is a perspective view illustrating a process of manufacturing a lower part of an antenna unit in a manufacturing process of the antenna apparatus;

FIG. 6 is a perspective view illustrating a process of manufacturing an upper part of the antenna unit in the manufacturing process of the antenna apparatus;

FIG. 7 is a diagram illustrating a wavelength shortening effect using an electromagnetic simulation;

FIG. 8 is a diagram illustrating a field intensity distribution in a configuration in which a GND pattern is provided in a substrate;

FIG. 9 is a diagram illustrating a directivity of the antenna apparatus;

FIG. 10 is a diagram illustrating a field intensity distribution of a comparative example;

FIG. 11 is a diagram illustrating a directivity of a comparative example;

FIG. 12 is a diagram illustrating a relationship between gain and the numbers of turns of two elements;

FIG. 13 is a diagram illustrating an electric field intensity distribution when the number of turns n of the inner element is three and the number of turns m of the outer element is eighteen;

FIG. 14 is a diagram illustrating an electric field intensity distribution when the number of turns n of the inner element is nine and the number of turns m of the outer element is sixteen point five;

FIG. 15 is a perspective view illustrating an outline configuration of an antenna apparatus according to a second embodiment of the present invention;

FIG, 16 is a diagram illustrating a relationship between gain and the numbers of turns of two elements; and

FIG. 17 is a perspective view of a modification example.

### DETAILED DESCRIPTION OF THE PREFERRED EMBODIMENTS

The following describes embodiments of the present invention with reference to drawings.

### First Embodiment

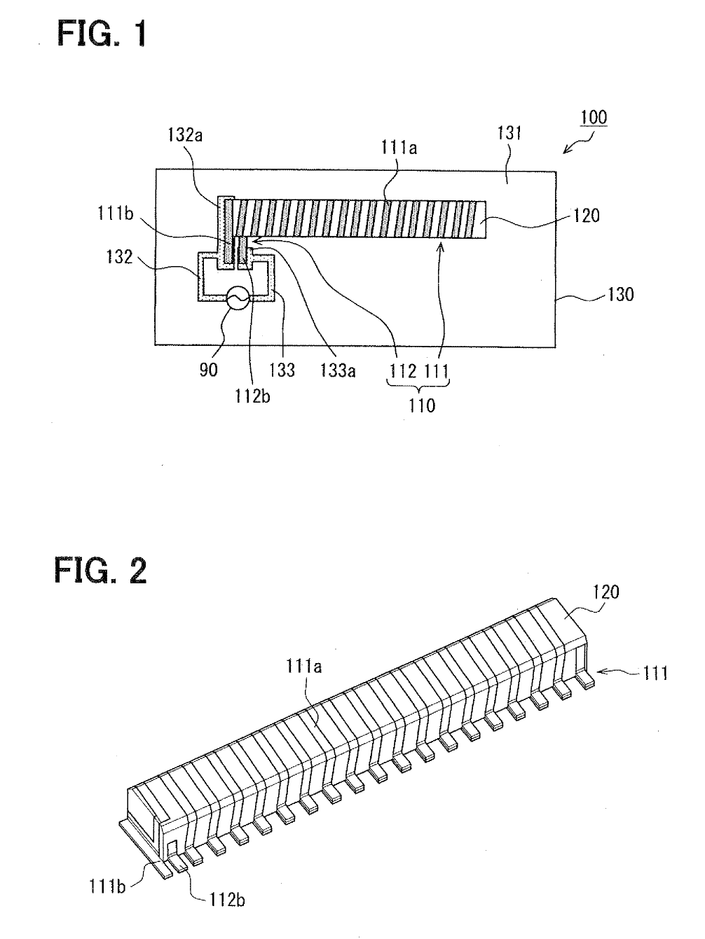

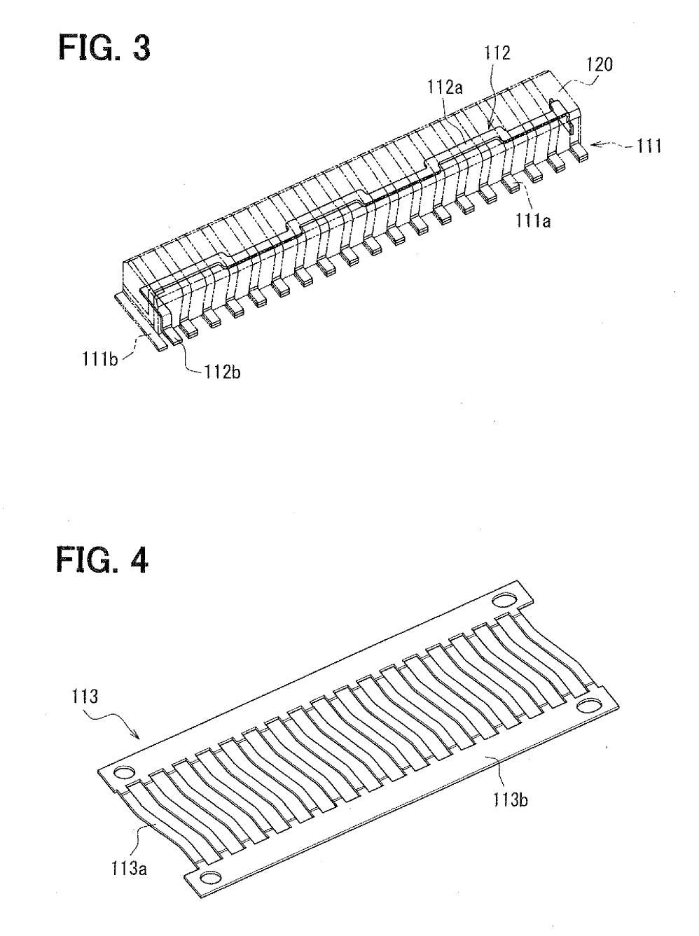

FIG. 1 is a plan view (viewed from a point over a top surface of a substrate) illustrating an outline configuration of an antenna apparatus according to a first embodiment of the present invention. FIG. 2 is a perspective view of a periphery of the antenna. FIG. 3 is a perspective view virtually transparently illustrating an inner element of the antenna in FIG. 2. Furthermore, the antenna apparatus according to the present embodiment is included as a receiver in a keyless remote system for vehicles.

As illustrated in FIGS. 1 to 3, the antenna apparatus 100 includes: an antenna 110 of a terminal open type mainly having two elements 111, 112; a support member 120 supporting or holding the two elements 111, 112 in a predetermined positional relationship; and a substrate 130 on which the antenna 110 and support member 120 united with the antenna 110 are mounted. Furthermore, the substrate 130 is configured of a base member made of insulating material (for example, a resin base member with a dielectric constant of about three).

As shown in FIGS. 1 to 3, the antenna 110 includes the outer element 111 and the inner element 112. The outer element 111 has a spiral section 111a spirally prolonged along (in approximately parallel with) a front surface 131 of the substrate 130. The inner element 112 has a spiral section 112a, which is spirally prolonged in an axial direction of the spiral section 111a of the outer element 111 (hereinafter referred to as “the axial direction” or “axially”) while being arranged inside of the spiral section 111a with an interval spaced from the spiral section 111a. Each element 111, 112 is connected with a feed point 90 at a terminal end 111b. 112b (also referred to as mount section 111b, 112b ) in one end portion of both the two end portions in the axial direction and coupled with a high frequency source (alternating power source) via the feed point 90. Thus, in the antenna 110, one of the two elements 111, 112 functions as a signal line, and the other functions as a GND line; further, the signal line and the GND line are periodically switched therebetween because of the high frequency current, thereby forming a terminal open type antenna with an RLC series resonance structure. Furthermore, the present antenna 110 is comparable with an antenna described in Patent document 2 filed by the present Applicant except that the direction of the axial direction relative to the front surface 131 of the substrate 130 differs; therefore, the following omits the detailed description about the comparable structure and effect.

In the present embodiment, as shown in FIG. 3, the antenna 110 is provided with the spiral sections 111a, 112a having respective lengths approximately equal to each other. In such a configuration, the secondary electric current (image electric current) due to the electric current which flows through the outer element 111 acts on the inner element 112 efficiently; thus, the antenna gain can be improved more. In other words, the physique of the antenna apparatus can be miniaturized more effectively. Furthermore, the elements 111, 112 are arranged such that the central axes thereof are concentrically or coaxial. For example, the cross-sectional shape of a spiral of each element 111, 112, may be approximately circular, approximately rectangular, polygonal other than rectangular, etc without need to be limited specifically.

Further, in the present embodiment, a pitch between spirals or turns of the spiral section 112a in the inner element 112 (interval of mutually adjoining turns of the spiral section 112a in the axial direction) is designed larger than a pitch between the spirals or turns of the spiral section 111a in the outer element 111 (interval of mutually adjoining turns of the spiral section 111a in the axial direction); thus, the number of turns n of the spiral section 112a is less (n<m) than the number of turns m of the spiral section 111a. Such a relationship between the numbers of turns n, m in the two elements 111, 112 is a main characteristic of the present embodiment; thus, more details are explained later. In addition, in the present embodiment, the number of turns n of the spiral section 112a in the inner element 112 is three; the number of turns m of the spiral section 111a in the outer element 111 is eighteen. That is, the number of turns n is less than the number of turns m.

In addition, the mount section 111b, 112b of each element 111, 112 is provided as a so-called surface mount structure; each mount section 111b, 112b is arranged on the corresponding land 132a, 133a provided in the front surface 131 of the substrate 130 and connected with the land 132a, 133a via solder (none shown). More specifically, with respect to the two elements 111, 112, the terminal ends existing at the same end portion of both the end portion in the axial direction are arranged in approximately parallel with the front surface 131 of the substrate 130 while configuring or functioning as the mount sections 111b, 112b, respectively. In addition, the lands 132a, 133a are on the substrate 130 for functioning as connection sections (electrodes) connected with the individual elements 111, 112; the lands 132a, 133a are in the wire sections 132, 133 connected with the feed point 90. Thus, when the surface mount structure is adopted as a structure of the mount sections 111b, 112b, it is possible to carry out the package mounting of the two elements 111, 112 on the substrate 130 using reflow, improving the efficiency of the mounting of the elements 111, 112 on the substrate 130. Also in the present embodiment, the package mounting of each element 111, 112 collectively to the substrate 130 is carried out using the reflow.

Further, as described above, the antenna 110 has a so-called die-pole structure with respect to the two elements 111, 112 such that the inner element 112 is contained inside of the outer element 111 while having a predetermined interval space so as to be spaced from each other. Thus, the positional relationship of the two elements 111, 112 is important to the performance (resonance characteristic) of the antenna 110. For instance, the capacity of the capacitor constructed in the region, in which the two elements 111, 112 face each other, changes based on the dimension of the above interval space; accordingly, the resonance frequency is changed and the radiation property is affected.

In order to solve such a problem, i.e., in order to maintain the performance of the antenna 110, the support member 120 is arranged to contact each of the spiral sections 111a, 112a of the two elements 111, 112, respectively, to thereby maintain the two elements 111, 112 at a predetermined positional relationship. The support member 120 causes the central axes of the outer element 111 and inner element 112 to accord with each other.

In addition, the support member 120 is constructed of dielectrics (or referred to as a dielectric member). Therefore, the wavelength shortening of the high frequency current flowing in the elements 111, 112 (spiral sections 111a, 112a) arises. The resonance frequency of the antenna 110 can be shifted to a lower range compared with the configuration of no dielectrics provided. In other words, on the assumption that the same resonance frequency is maintained, the electric length (the length of the element 111, 112) is shortened compared with the configuration provided with no dielectrics. The physique of the antenna 110 (eventually, the physique of the antenna apparatus 100) can be therefore miniaturized.

In the present embodiment, the support member 120 is constructed of the dielectrics, which is a mixed material of resin and ceramic while having a dielectric constant (ε) of 20 having a heat resistance against the reflow mounting. The support member 120 is an approximately rectangular solid having, in the axial direction, a length a little longer than the length of each spiral section 111a, 112a. For example, the length is 24 mm in the axial direction, 3 mm in the direction orthogonal to the axial direction and along the front surface 131 of the substrate 130, and 2 mm in the direction orthogonal to the front surface 131. The whole part of the spiral section 112a of the inner element 112 is arranged inside of the support member 120. That is, the support member 120 is arranged around the spiral section 112a so that the spiral section 112a can be thoroughly covered. In addition, the spiral section 111a of the outer element 111 is arranged in line with the axial direction so as to wind around a surface (external surface) of the support member 120. In other words, the support member 120 is arranged to intervene between the spiral sections 111a, 112a of the two elements 111, 112 in the whole region in which the two spiral sections 111a, 112a oppose each other.

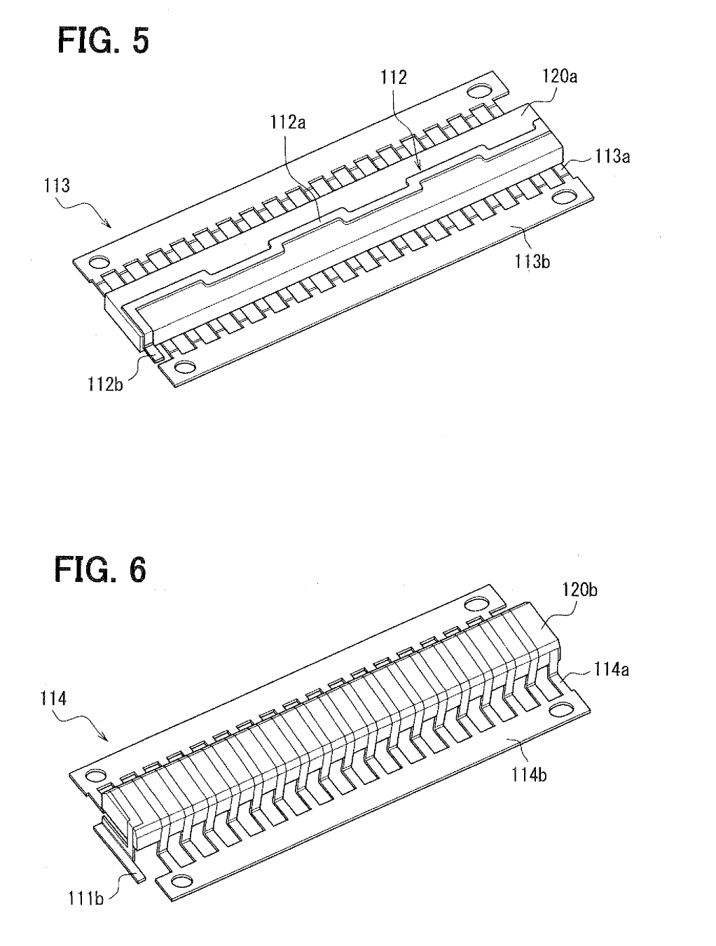

Next, the following explains an example of a method for manufacturing the antenna apparatus 100 having the above configuration. FIG. 4 is a perspective view illustrating an outline configuration of a lead frame which constitutes a lower portion of the outer element 111. FIG. 5 is a perspective view illustrating a process of manufacturing a lower part of a unit (also referred to as an antenna unit) in a manufacturing process of the antenna apparatus 100. FIG. 6 is a perspective view illustrating a process of manufacturing an upper part of the antenna unit in the manufacturing process of the antenna apparatus 100. More specifically, the direction indicated by the above “upper” and “lower” signifies an approximately orthogonal direction (hereafter referred to as only “orthogonal direction”) with respect to the front surface 131 of the substrate 130. The lower side is located closer to the front surface 131 while the upper side is located farther from the front surface 131.

First, the two elements 111, 112 constituting the antenna 110, the support member 120, and the substrate 130 are prepared, respectively. According to the present embodiment, the inner element 112 having the predetermined number of turns n is prepared through applying a punch, bend, etc. to a metal plate, as shown in FIG. 5.

In addition, as illustrated in FIGS. 4 to 6, the outer element 111 is prepared by dividing in the orthogonal direction into two parts of a lower element 113a and an upper element 114a. The lower element 113a is, of the spiral section 111a, a portion arranged on the front surface 131 of the substrate 130. The lower element 113a is prepared as a part of a lead frame 113 as illustrated in FIGS. 4, 5 by applying punches and bends to a metal plate. Furthermore, the reference number 113b illustrated in FIGS. 4, 5 is a connection section 113b which connects the lower element 113a at each end side in the longitudinal direction of the lower element 113a (spiral section 111a). The connection section 113b is unnecessary for functioning as the antenna 110; thus, it is removed later. In addition, the upper element 114a corresponds to a part of the outer element 111 excluding the lower element 113a (the mount section 111b and part of the spiral section 111a). The upper element 114a is prepared as a part of a lead frame 114 as illustrated in FIG. 6 by applying punches and bends to a metal plate. Furthermore, the reference number 114b illustrated in FIG. 6 is assigned to a connection section 114b which connects respective parts of the spiral section 111a at respective end sides in the longitudinal direction of the upper element 114a. The connection section 114b is unnecessary for functioning as the antenna 110, either; thus, it is removed later.

In addition, as illustrated in FIGS. 5, 6, the support member 120 made of dielectrics is prepared by dividing in the orthogonal direction into two parts of a lower support member 120a and an upper support member 120b. The lower support member 120a is formed in a shape of an approximately rectangular solid using the mixed material of resin and ceramics, as described above. The lower support member 120a is provided with a groove (not shown), in which the inner element 112 is inserted, from a top surface to a side surface. Further, the lower support member 120a is provided with a groove (not shown), in which the lower element 113a is inserted, in a bottom surface. The upper support member 120b is also formed in a shape of an approximately rectangular solid using the same material as the lower support member 120a. The upper support member 120b is provided with a groove (not shown), in which the upper element 114a is inserted, from a top surface to a side surface.

Next, while the lower element 113a of the lead frame 113 is inserted into the groove of the lower support member 120a, the inner element 112 is inserted into the corresponding groove. Thus, the lower support member 120a, the inner element 112, and the lead frame 113 are integrated into a unit. In addition, the upper element 114a of the lead frame 114 is similarly inserted into the groove in the upper support member 120b. Thus, the upper support member 120b and the lead frame 114 are integrated into a unit. Then, the lower support member 120a and the upper support member 120b are inserted into each other to thereby be integrated into the support member 120 as a unit. Thereby, the spiral section 112a of the inner element 112 is covered with the support member 120. In addition, the lower element 113a and the upper element 114a which constitute the spiral section 111a of the outer element 111 are overlapped at the mutually facing end portions.

Next, the overlapped portion of the lower element 113a and the upper element 114a is irradiated with the laser beam, and laser welded. After the laser welding, the connection sections 113b, 114b, which are the unnecessary part of the lead frames 113, 114, are removed. The unit of the antenna 110 and the support member 120 is thereby formed as illustrated in FIGS. 2, 3.

Next, the solder (not shown) is applied using a screen printing or dispenser on the lands 132a, 133a of the substrate 130 prepared separately. The unit of the antenna 110 and support member 120 is positioned on the front surface 131 of the substrate 130 such that the mount sections 111b, 112b are arranged on the corresponding lands 132a, 133a. Under the condition that the above unit is accurately positioned, the reflow is applied so as to join up the mount sections 111b, 112b and the corresponding lands 132a, 133a via the solder, thereby forming the above-mentioned antenna apparatus 100.

Furthermore, when the unit of the antenna 110 and support member 120 is arranged on the substrate 130, any point other than the mount sections 111b, 112b may be fixed to the front surface 131 of the substrate 130. Thereby, the mounting structure of the antenna 110 on the substrate 130 can be also stabilized. For example, a part of the outer element 111 (for example, a laser welding portion, or a bottom part of the support member 120) may be used as a connection section with the substrate 130, the connection section which does not provide an electrical connection function (i.e., nonconductive connection).

Next, the following explains an effect of the antenna apparatus 100 according to the present embodiment. In the antenna apparatus 100 according to the present embodiment, the support member 120 allows the two elements 111, 112 to be held in the predetermined positional relationship. Therefore, although both the two elements 111, 112 have the spiral sections 111a, 112a prolonged along the front surface 131 of the substrate 130, the performance of the antenna 110 can be maintained.

In addition, the support member 120 is configured of the dielectrics.

Therefore, with help of the wavelength shortening of the high frequency current by the support member 120 (dielectrics), the resonance frequency of the antenna 110 can be shifted to a lower range compared with the configuration provided with no dielectrics. In other words, on the assumption that the same resonance frequency is maintained, the electric length (the length of the element 111, 112) is shortened compared with the configuration provided with no dielectrics. The physique of the antenna 110 (eventually, the physique of the antenna apparatus 100) can be miniaturized. This can be clearly explained by the following. In the capacitor configured of the two elements 111, 112, the capacity becomes large as the dielectric constant of the dielectrics becomes large; accordingly, the resonance frequency of the antenna 110 of the RLC series resonance circuit becomes smaller. In addition, the influence of the wavelength shortening effect mentioned above is large as the dielectric constant of the dielectrics included in the support member 120 is large; thus, the physique of the antenna apparatus 100 can be miniaturized more effectively.

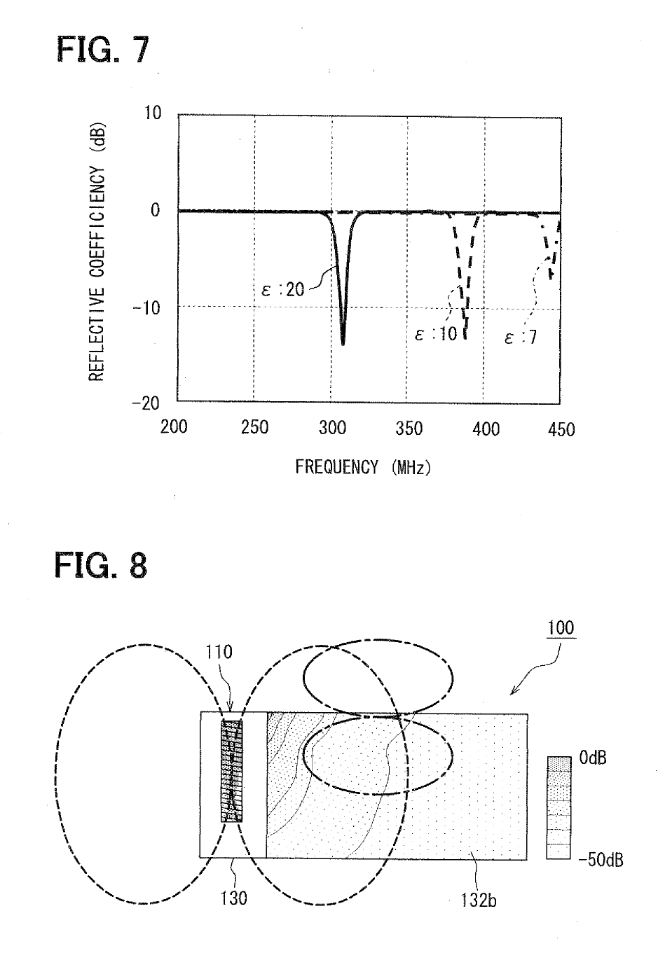

Furthermore, the present Inventors confirmed the wavelength shortening effect due to the dielectric constant in the antenna apparatus 100 according to the present embodiment as shown in FIG. 7. FIG. 7 illustrates the wavelength shortening effect using the electromagnetic simulation. The horizontal axis indicates a frequency and the vertical axis indicates a reflective coefficient. In FIG. 7, the antenna apparatus 100 having a dielectric constant of 20 according to the present embodiment is indicated by the solid line. As a comparative example having the same configuration, the antenna apparatus 100 having dielectric constant of 10 or 7 is indicated by the broken line or the chain line, respectively. Furthermore, the electric length is assumed to be equal on each condition. As illustrated in FIG. 7, with respect to the antenna apparatus 100 (dielectric constant of 20) of the present embodiment, the resonance frequency is 310 MHz. In contrast, with respect to a dielectric constant of 10 or 7, the resonance frequency is 380 MHz or 444 MHz, respectively. This clearly indicates that the influence of the wavelength shortening effect becomes large as the dielectric constant of the dielectrics constituting the support member 120 becomes large. Therefore, if the same resonance frequency is secured, the electric length can be shortened and the physique of the antenna apparatus 100 can be miniaturized more effectively in the present embodiment.

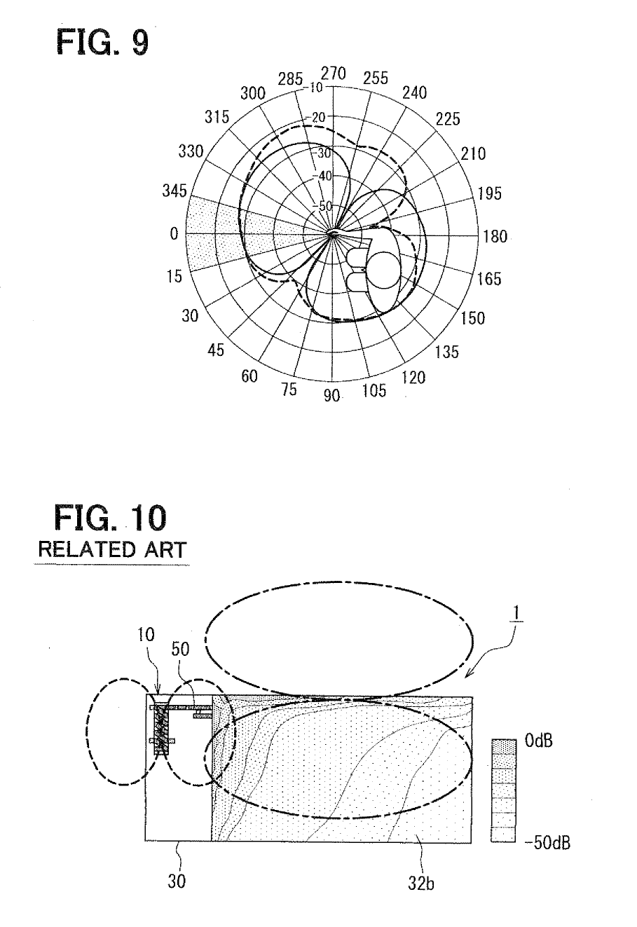

Further, in the present embodiment, the effect from adopting a double spiral structure of the two elements 111, 112 in the antenna 110 and the above-mentioned wavelength shortening effect due to the dielectrics enable the antenna 110 to acquire a resonance characteristics by itself, without need of a matching circuit, i.e., without need of inserting an inductor between the antenna 110 and a GND pattern 132b on the substrate 130. Therefore, for example, as illustrated in FIG. 8, even though the GND pattern 132b is provided as a part of the wire section 132, the influence of the GND pattern 132b is small (the radiation from the substrate 130 is small as indicated by the chain line in FIG. 8) and the radiant efficiency of the antenna 110 becomes high (the radiation from the antenna 110 is high as indicated by the broken line in FIG. 8). Therefore, the radio wave can be emitted in the direction of the front. This is clear also from FIG. 9 of the directivity indicating a field intensity at a 3-m spot. Furthermore, the directivity can be achieved as being concentric when a person holds the antenna apparatus 100, as shown by the broken line in FIG. 9. FIG. 8 illustrates a field intensity distribution when the GND pattern 132b is configured as a part of the wire section 132. FIG. 9 illustrates the directivity of the antenna apparatus 100. The solid line indicates the directivity in the antenna apparatus alone.

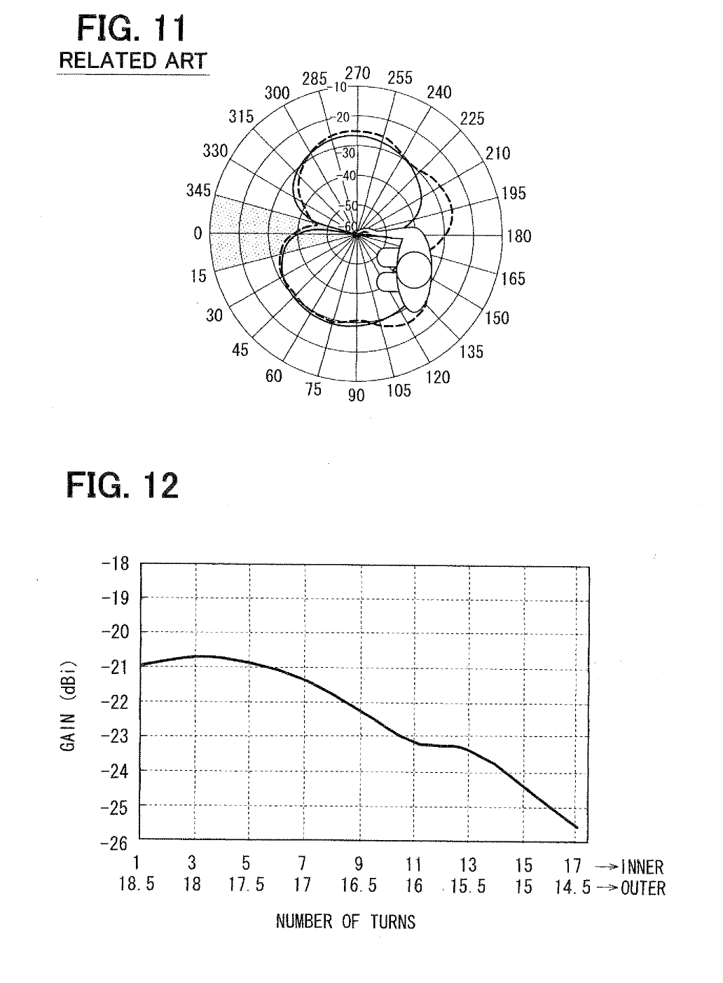

Furthermore, a comparative example against FIGS. 8, 9 is shown in FIGS. 10, 11. In an antenna apparatus 1 in FIG. 10, an antenna 10 is a typical chip antenna. In order to acquire a resonance characteristic, multiple inductors 50 are inserted between the antenna 10 and a GND pattern 32b of a substrate 30. That is, the matching circuit is needed. A large electric current is induced on the substrate 30 (i.e., the GND pattern 32b) in the antenna apparatus 1, as illustrated in FIG. 10. Thus, the influence of the GND pattern 32b is large (the radiation from the substrate 30 is large as indicated by the chain line in FIG. 10) and the radiant efficiency of the antenna 10 becomes small (the radiation from the antenna 10 is small as indicated by the broken line in FIG. 10). Therefore, it is hard for the radio wave to be emitted in the direction of the front. This is clear also from FIG. 11 of the directivity indicating a field intensity at a 3-m spot.

In addition, in the present embodiment, the mount section 111b, 112b of each element 111, 112 is provided as a surface mount structure. Each mount section 111b, 112b is thus arranged on the corresponding land 132a, 133a provided in the front surface 131 of the substrate 130 and connected with the land 132a, 133a via solder (none shown). It is therefore possible to carry out the package mounting of the two elements 111, 112 on the substrate 130 using reflow. The efficiency of mounting of the elements 111, 112 to the substrate 130 can be improved.

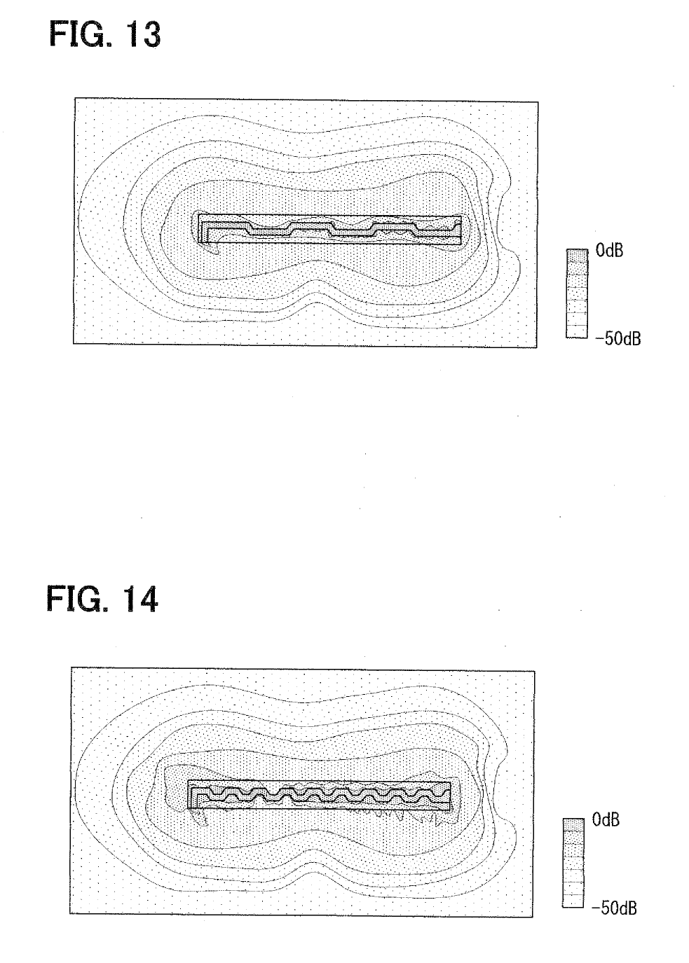

Further, in the present embodiment, with respect to the two elements 111, 112 which constitute the antenna 110, the number of turns n of the spiral section 112a in the inner element 112 is less (n<m) than the number of turns m of the spiral section 111a in the outer element 111. The present Inventors confirmed a relationship between an antenna gain and the numbers of turns of the elements 111, 112 in the antenna apparatus 100 of the present embodiment as shown in FIG. 12, for instance. When the number of turns n of the spiral section 112a in the inner element 112 is equal to or less than the number of turns m of the spiral section 111a in the outer element 111, i.e., n<=m, the antenna gain of the antenna 110 is clearly large compared with a configuration in which the number of turns n of the spiral section 112a is greater than the number of turns m of the spiral section 111a in the outer element 111. In addition, it becomes clear that under the condition that the inner element 112 has the spiral section 112a and the number of turns n of the spiral section 112a is less than the number m of turns of the spiral section 111a of the outer element 111, the number of turns having the largest gain of the antenna 110 exists. In FIG. 12, in the above-mentioned antenna apparatus 100, under the condition of tan δ=0.006 (i.e., almost the minimum electrostatic tangent for the well-known dielectrics), the simulation result is illustrated with respect to the relationship between the gain and the numbers n, m of turns of the elements 111, 112. The gain is the maximum when the number of turns n of the inner element 112 is three and the number of turns m of the outer element 111 is eighteen. Based on the above result, in the antenna apparatus 100 according to the present embodiment, the number of turns n of the inner element 112 is three and the number of turns m of the outer element 111 is eighteen. In addition, the present Inventors confirmed the relationship between the number of turns n of the spiral section 112a of the inner element 112 and the field intensity distribution, which is shown in FIGS. 13, 14. FIG. 13 is a diagram illustrating an electric field intensity distribution when the number of turns n of the inner element 112 is three and the number of turns m of the outer element 111 is eighteen. FIG. 14 is a diagram illustrating an electric field intensity distribution when the number of turns n of the inner element 112 is nine and the number of turns m of the outer element 111 is sixteen point five (16.5). FIGS. 13, 14 clearly indicate that under the condition where the electric length is constant, the field intensity inside of the support member 120 (dielectrics) becomes high as the number of turns n of the spiral section 112a of the inner element 112 becomes large.

As explained above, under the condition that the number of turns n of the spiral section 112a is less than the number of turns m of the spiral section 111a of the outer element 111, the number of turns having the greatest gain of the antenna 110 exists. Such a characteristic may be explained from the reason as follows. In the configuration in which the support member 120 formed of dielectrics makes a contact to each element 111, 112, in particular, according to the configuration of the present embodiment where the spiral section 112a of the inner element 112 is covered by the support member 120, the support member 120 (dielectrics) is affected by the influence of the electric field due to the inner element 112 rather than the outer element 111. As the number of turns n of the spiral section 112a in the inner element 112 is larger, the interval of the adjoining turns of the spiral section 112a in the axial direction is shorter, thereby forming the unnecessary electrical coupling portion (stray capacitance portion) between the turns of the spiral section 112a. The intensity of electric field thus becomes high inside of the support member 120 (dielectrics). Such electric field causes an electrostatic tangent (tan δ: also referred to as dielectric loss or dielectric tangent), which is a characteristic peculiar to the dielectrics. The gain of the antenna 110 thus falls as a heat loss. In addition, when the dielectrics (support member 120) does not exist, i.e., tan δ=0, the electrostatic tangent does not arise. As the number of turns n of the spiral section 112a in the inner element 112 increases, the number of turns m of the spiral section 111a in the outer element 111 decreases, thereby increasing the radiant quantities outputted from the antenna 110. Because of those two characteristics, with respect to the configuration for the support member 120 formed of the dielectrics to contact each element 111, 112, on the condition that the inner element 112 has the spiral section 112a and the number of turns n of the spiral section 112a in the inner element 112 is less than the number of turns m of the spiral section 111a in the outer element 111, it is supposed that the number of turns having the largest gain of the antenna 110 exists. Furthermore, FIG. 12 illustrates the relationship between the gain and the numbers of turns m, n of the elements 111, 112 when tan δ=0.006 (almost the minimum electrostatic tangent as a well-known dielectrics). However, even if the electrostatic tangent (tan δ) can be different from the above, the comparable characteristic arises.

As described above, it is designed in the present embodiment that the number of turns n of the spiral section 112a in the inner element 112 is less than the number of turns m of the spiral section 111a in the outer element 111. The configuration in which the support member 120 of the dielectrics abuts to each element 111, 112, can thereby improve the antenna gain. In other words, if the antenna gain is almost the same, compared with the configuration in which the number of turns n of the spiral section 112a in the inner element 112 is greater than the number of turns m of the spiral section 111a in the outer element 111, the physique of the antenna 110 (eventually, the physique of the antenna apparatus 100) can be miniaturized more effectively.

In addition, in the present embodiment, the spiral sections 111a, 112a of the two elements 111, 112 which constitute the antenna 110 are prolonged along the front surface 131 of the substrate 130. That is, the antenna 110 is arranged in the direction approximately parallel with the front surface 131 of the substrate 130. Further, as described above, in the antenna apparatus which uses the radio wave having a comparatively long wavelength (tens of centimeters to several meters), the physique of the antenna is dominant to the physique or dimensions of the antenna apparatus. In addition, the direction approximately orthogonal to the front surface 131 of the substrate 130 is more influential to the physique of the antenna apparatus 100 than the direction approximately parallel to the front surface 131. Thus, the physique of the antenna apparatus 100 according to the present embodiment can be miniaturized more effectively than the antenna configuration in which the axial direction of the spiral sections 111a, 112a approximately orthogonal to the front surface 131 of the substrate 130.

Furthermore, the method for manufacturing of the antenna apparatus 100 concerning the present embodiment is not limited to the above example. Alternatively, for instance, a metal line (wire) may be processed to prepare the two elements 111, 112, and the prepared two elements 111, 112 are then inserted in the groove of the support member 120 (120a, 120b) of the above mentioned configuration, to thereby form the configuration in which the antenna 110 and the support member 120 are integrated into a unit. In addition, when carrying out the injection molding of the support member 120, at least one of the two elements 111, 112 may be dealt with as an insertion part.

### Second Embodiment

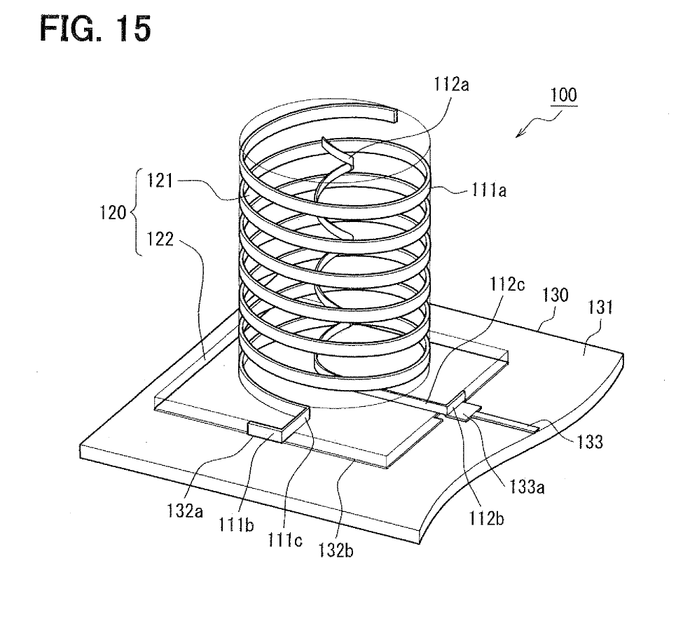

The following describes a second embodiment of the present invention with reference to FIGS. 15, 16. FIG. 15 is a perspective view illustrating an outline configuration of an antenna apparatus according to a second embodiment of the present invention. FIG. 16 illustrates the relationship between the antenna gain and the numbers of turns of the two elements. FIG. 16 corresponds to FIG. 12 in the first embodiment.

The antenna apparatus according to the second embodiment has a configuration almost similar to that of the first embodiment. Detailed explanation is mainly made with respect to different portions therebetween. Furthermore, the same reference numbers are given to the same elements as the elements illustrated in the first embodiment.

In the first embodiment, the axial direction of the spiral sections 111a, 112a in the two elements 111, 112 is exemplified as being approximately parallel to the front surface 131 of the substrate 130. In contrast, the present second embodiment is characterized in that, as illustrated in FIG. 15, the axial direction of the spiral sections 111a, 112a in the two elements 111, 112 is orthogonal to the front surface 131 of the substrate 130 Except for the above difference, the antenna apparatus 100 according the second embodiment has a configuration almost comparable with that of the first embodiment shown in FIG. 1.

Furthermore, similarly, in the antenna apparatus 100 shown in FIG. 15, the number of turns n of the spiral section 112a in the inner element 112 is equal to or less than the number of turns m of the spiral section 111a in the outer element 111. More specifically, the number of turns n of the spiral section 112a in the inner element 112 is three while the number of turns m of the spiral section 111a in the outer element 111 is seven; therefore, the number of turns n is less than the number of turns m.

In addition, in a GND pattern 132b arranged as a wire section 132 on the front surface 131 of the substrate 130, a land 132a is provided as a connection portion (a portion of the GND pattern 132b) connected with a mount section 111b of the outer element 111. In the front surface 131 of the substrate 130, the GND pattern 132b is formed in a shape of a plane appropriately rectangle while corresponding to the arrangement position of the antenna 110 so that the antenna 110 may be arranged on the GND pattern 132b. A land 133a is provided near the GND pattern 132b. A wire section 133 is provided to extend in a direction to separate from the GND pattern 132b while terminating at the land 133a.

In addition, the support member 120 has a support section 121 and a base section 122. The support section 121 contacts the spiral sections 111a, 112a of the two elements 111, 112 and supports or maintains a positional relationship therebetween; the base section 122 is provided on the GND pattern 132b. The support section 121 is formed to extend from the lower end of the spiral sections 111a. 112a to the position a little higher than the upper end, and is provided as intervening in the whole range in which the spiral sections 111a, 112a face each other. The base section 122 is formed above the GND pattern 132b with the size a little smaller than the GND pattern 132b. Inside of the base section 122, joint sections 111c, 112c are provided to join the mount sections 111b, 112b with the spiral sections 111a, 112a in the two elements 111, 112 while not contacting the GND pattern 132b. In addition the mount sections 111b, 112b are exposed from the end surface (side) of the base section 122 and connected with the lands 132a, 133a, respectively.

The antenna apparatus 100 according to the second embodiment can provide an effect similar to that of the first embodiment. For example, the two elements 111, 112 are held by the support member 120 (especially support section 121) at the predetermined positional relationship, enabling the performance of the antenna 110 to be maintained. In addition, the support member 120 is formed using dielectrics; thus, the physique of the antenna 110 (as a result, the physique of the antenna apparatus 100) can be miniaturized based on the wavelength shortening effect due to the high frequency current. Further, the effect from adopting a double spiral structure of the two elements 111, 112 in the antenna 110 and the above-mentioned wavelength shortening effect due to the dielectrics enable the antenna 110 to acquire a resonance characteristic by itself, without need of a matching circuit, i.e., without need of inserting an inductor between the antenna 110 and the GND pattern 132b. Therefore, the radio wave can be emitted in the direction of the front. Furthermore, the mount sections 111b, 112b of each element 111, 112 are provided as a surface mount structure, it is possible to carry out the package mounting of the two elements 111, 112 on the substrate 130 using reflow.

Further, it is designed in the present embodiment that the number of turns n of the spiral section 112a in the inner element 112 is less than the number of turns m of the spiral section 111a in the outer element 111. Therefore, the antenna gain can be improved by the configuration in which the support member 120 formed of the dielectrics contacts each element 111, 112. In other words, if the antenna gain is almost the same, compared with the configuration in which the number of turns n of the spiral section 112a in the inner element 112 is greater than the number of turns m of the spiral section 111a in the outer element 111, the physique of the antenna 110 (eventually, the physique of the antenna apparatus 100) can be miniaturized more effectively.

Furthermore, also the present Inventors confirmed the relationship between the antenna gain and the numbers of turns m, n of the two elements 111, 112 in the antenna apparatus 100 of the second embodiment described above. That is, when the number of turns n of the spiral section 112a is equal to or less than the number of turns m of the spiral section 111a of the outer element 111, the antenna gain can be improved compared with the configuration of n>m. FIG. 16 illustrates such a result as an example having the above configuration of the antenna apparatus 100. More specifically, the simulation result is illustrated with respect to the relationship between the gain and the numbers n, m of turns of the elements 111, 112 on the condition of tan δ=0.006. In the present result, when the number of turns n of the inner element 112 is three while the number of turns m of the outer element 111 is seven, the gain indicates the maximum. Based on the result, in the antenna apparatus 100 according to the present second embodiment, the number of turns n of the inner element 112 is three and the number of turns m of the outer element 111 is seven.

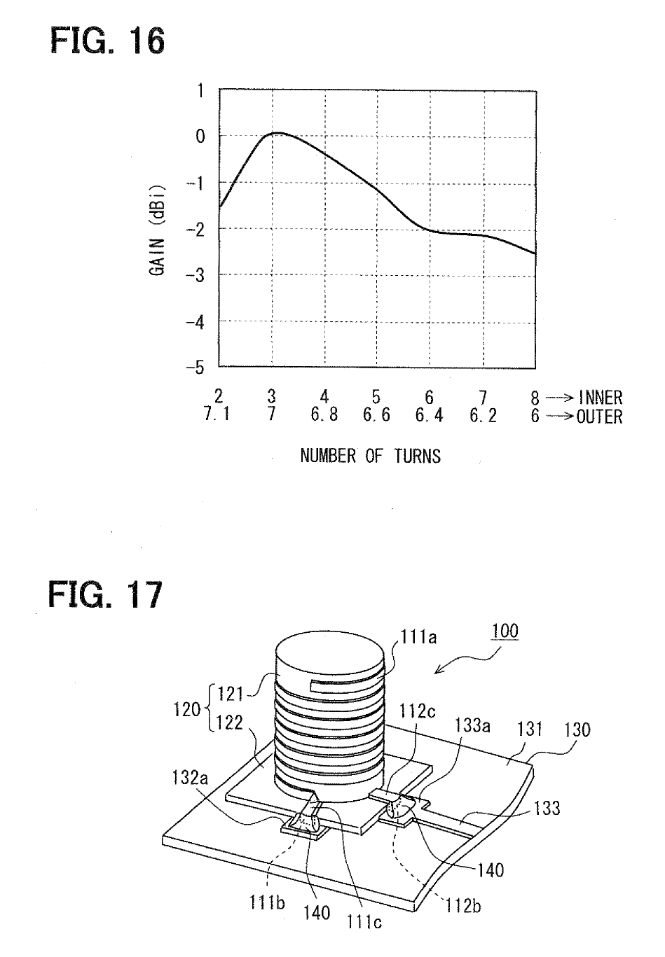

In addition, in the present embodiment, the joint section 111c, 112c of each element 111, 112 is laid inside of the base section 122. In contrast, for instance, as shown in FIG. 17, while each joint section 111c, 112c is arranged approximately parallel to the front surface 131 of the substrate 130, each joint section 111c, 112c may be laminated over the base section 122. That is, the joint sections 111c, 112c may be provided as a strip line structure. Furthermore, in the example illustrated in FIG. 17, the base section 122 is made shaped of a plate, which has larger area dimensions than the GND pattern 132b (not shown) shaped of a rectangular plate; the base section 122 is laminated over the GND pattern 132b. Such a laminated state can be seen, from a position above the front surface 131 of the substrate 130, such that the GND pattern 132b is covered by the base section 122 and only the land 132a is exposed outside of the base section 122. In addition, each joint section 111c, 112c of each element 111, 112 is held as a united object in the base section 122 on a surface reverse to the surface contacting with the GND pattern 132b. Thus, when the joint sections 111c. 112c are made as a strip line structure using the support member 120, the impedance of the antenna 110 is stabilized, thereby suppressing the variation in the performance of the antenna 110. In addition, the support member 120 (base section 122) laminated over the GND pattern 132b also contributes to the wavelength shortening effect significantly, thus shifting the resonance frequency of the antenna 110 to a lower range. Furthermore, the physique of the antenna apparatus 100 can be miniaturized much more effectively. In addition, in the present embodiment, the joint sections 111c, 112c of the base section 122 are held on the front surface of the support member 120; thus, the effect for holding the elements 111, 112 using the support member 120 can be enhanced. In addition, the accuracy of positioning the joint sections 111c, 112c over the lands 132a, 133a can be raised. FIG. 17 is a perspective view indicating a modification. The reference number 140 in FIG. 17 indicates a solder.

Furthermore, a strip line structure may not be limited to the above example. For instance, another strip line structure may be exemplified as follows. The support member 120 has only the support section 121. The GND pattern 132b is formed in the rear surface reverse to the front surface 131 of the substrate 130. The joint sections 111c, 112c (a part of the elements 111, 112) are layered above the GND pattern 132b via the substrate 130.

Further, in the present second embodiment, the GND pattern 132b is formed directly under the antenna 110 on the front surface 131 of the substrate 130 as a part of the wire section 132. Alternatively, the GND pattern 132b can be arranged in the substrate 130 at a position, which is different from the position directly under the antenna 110. No GND pattern 132b may be provided as a part of the wire section 132. Furthermore, no base section 122 may be provided.

(Modification)

The preferred embodiment of the present invention is thus described; however, without restricted to the embodiment mentioned above, the present invention can be variously modified as long as not deviating from the scope thereof.

In the present embodiment, the antenna apparatus 100 is applied to the in-vehicle keyless receiver However, the antenna apparatus 100 may be applied without limited to the above example. It is also applicable to another antenna apparatus such as a smart entry system. In addition, needless to say, it may be applicable not only to the receiver but also to the transmitter.

The present embodiment explains the example in which the spiral section 112a of the inner element 112 is covered by the support member 120 made of the dielectrics and the spiral section 11la of the outer element 111 winds around the surface (external surface) of the support member 120. However, the configuration of the support member 120 is not limited to the above example. The support member is minimally required to contact the spiral sections 111a, 112a and hold the two elements 111, 112 in the predetermined positional relationship. For example, the support member 120 may be also provided inside of the spiral section 112a of the inner element 112. The support member 120 may be provided outside (or outer periphery) of the spiral section 111a of the outer element 111. Furthermore, the support member 120 may be provided for a part of the range in which the spiral sections 111a, 112a face each other. The portion of the support member 120 which contacts the element 111, 112 contributes to the wavelength shortening effect not a little; thus, the resonance frequency of the antenna 110 is shifted to a lower range and the physique of the antenna apparatus 100 can be miniaturized more effectively. It is noted that when the spiral section 111a of the outer element 111 is covered by the support member 120 made of the dielectrics, the influence of the number of turns of the outer element upon the antenna gain becomes large, compared with the configuration which is not covered with the support member 120. Thus, it is desirable that the spiral section 112a of the inner element 112 is covered by the support member 120 while the spiral section 111a of the outer element 111 winds around the external surface of the support member 120.

Aspects of the disclosure described herein are set out in the following clauses.

According to an aspect of the present disclosure, an antenna apparatus is provided as follows. An antenna and a support member are included. The antenna is a terminal open type including (i) an outer element, which has a spiral section prolonged spirally in an axial direction, and (ii) an inner element, which has a spiral section prolonged spirally in the axial direction and is surrounded, with an interval space, by the outer element. One of the two elements is a signal line, the other of the two elements is a GND line. The support member includes a dielectric member and contacting each of the spiral sections of the outer and inner elements while supporting the outer and inner elements in a predetermined positional relationship. Herein, a number of turns of the spiral section in the inner element is equal to or less than a number of turns of the spiral section in the outer element.

According to the above configuration, the two elements are held by the support member in the predetermined positional relationship, the performance of the antenna can be held. Furthermore, the two elements, which constitute the antenna, are connected with a feed point (high frequency wave source) at the same end portion along the axial direction of the spiral sections. Because of the high frequency current which flows through each element, one of the two elements is caused to function as a signal line while the other as a GND line. The signal line and the GND line thus change periodically between the two elements.

In addition, since the support member is formed using the dielectrics, the wavelength of the high frequency current flowing through the element can be shortened to thereby miniaturize the physique of the antenna.

In addition, the configuration, in which the support member formed of the dielectrics makes a contact to each element, causes an electrostatic tangent (tan δ: also referred to as dielectric loss or dielectric tangent), which is a characteristic peculiar to the dielectrics. However, like the present aspect, if it is designed that the number of turns of the spiral section in the inner element is equal to or less than the number of turns of the spiral section in the outer element, the loss due to the electrostatic tangent can be reduced. In short, the antenna gain can be improved rather than the configuration in which the number of turns of the spiral section in the inner element is greater than the number of turns of the spiral section in the outer element. That is, if the antenna gain is almost the same, the physique of the antenna can be miniaturized more effectively Such a point is confirmed by the present Inventors.

As an optional aspect of the antenna apparatus, the spiral section of the inner element may be covered by the support member while the spiral section of the outer element winds around an external surface of the support member.

Under such a configuration, the spiral section of the inner element is covered by the support member formed of the dielectrics; thus, the field intensity inside the support member is high to thereby potentially involve the electrostatic tangent. However, if the number of turns of the spiral section in the inner element is equal to or less than the number of turns of the spiral section in the outer element, the loss due to the electrostatic tangent can be reduced while the antenna gain can be improved or the physique of the antenna can be miniaturized more.

As an optional aspect of the antenna apparatus, in the axial direction of the spiral sections, lengths of the two elements may be approximately equal to each other. The support member may intervene between the spiral section of the outer element and the spiral section of the inner element in a range where the two spiral sections face each other.

In such a configuration, in addition to the foregoing effect, the secondary electric current from the outer element acts on the inner element efficiently. Thus, the antenna gain can be further improved or the physique of the antenna can be further miniaturized.

As an optional aspect, the antenna apparatus may further include a substrate having a surface on which two lands are respectively provided to be coupled with the high frequency wave source. The axial direction of the spiral sections in the two elements may be approximately parallel with the surface of the substrate forming the two lands. The two elements may have terminal ends, respectively, at a same end portion along the axial direction, the respective terminal ends of the two elements being coupled with the different lands, respectively.

As an optional aspect, the antenna apparatus may further include a substrate having a surface on which two lands are respectively provided to be coupled with the high frequency wave source. The axial direction of the spiral sections in the two elements may be approximately orthogonal to the surface of the substrate forming the two lands. The two elements may have terminal ends, respectively, at a same end portion along the axial direction. The respective terminal ends of the two elements may be coupled with the different lands, respectively.

In either optional aspect, the terminal end of each element is connected with the land provided in the same surface of the substrate; thus, it is possible to carry out the package mounting of the two elements on the substrate using reflow. Thereby, the efficiency of mounting of the antenna can be increased. Furthermore, the efficiency of mounting can be increased more by mounting the two elements in the state where both are held by the support member.

Further, as explained in the above, a wireless apparatus as an antenna apparatus for a keyless remote system (i.e., a so-called keyless receiver) uses a comparatively long wavelength (tens of centimeters to several meters) such as UHF or VHF band. In such an antenna apparatus, the size or dimensions of the antenna is dominant to the physique or dimensions of the whole antenna apparatus. The direction approximately orthogonal to the land formation surface in the substrate affects the dimensions of the antenna apparatus much more than the direction approximately parallel with the land formation surface. In the above configuration in which the axial direction of the spiral sections in the two elements is approximately parallel with the land formation surface of the substrate, the physique of the antenna apparatus can be miniaturized more effectively.

In the above configuration in which the axial direction of the spiral sections in the two elements is approximately orthogonal to the land formation surface of the substrate, the following can be provided as an optional aspect.

As an optional aspect of the antenna apparatus, one of the two lands may be electrically coupled with a GND pattern formed on the surface forming the lands in the substrate. Joint members joining the terminal ends of the elements to the spiral sections may be laminated above the GND pattern via the support member to thereby form a strip line structure.

Thus, when the joint section in the element is made as a strip line structure using the support member, the impedance of the antenna can be stabilized and the variation in the performance of the antenna can be suppressed. In addition, the support member arranged as being laminated or layered above the GND pattern contributes to the wavelength shortening effect significantly; thereby, the physique of the antenna apparatus can be miniaturized.

As an optional aspect of the antenna apparatus, the support member may be provided inside of the spiral section of the inner element while contacting the inner element. Similarly, the support member arranged inside of the spiral section of the inner element may contribute to the wavelength shortening effect significantly; thereby, the physique of the antenna apparatus can be miniaturized.

As an optional aspect of the antenna apparatus, the support member may provided outside of the spiral section of the outer element while contacting the outer element. Similarly, the support member arranged outside of the spiral section of the outer element contributes to the wavelength shortening effect significantly; thereby, the physique of the antenna apparatus can be miniaturized.

It will be obvious to those skilled in the art that various changes may be made in the above-described embodiments of the present invention. However, the scope of the present invention should be determined by the following claims.

What is claimed is:

1. An antenna apparatus comprising:
an antenna of a terminal open type including (i) an outer element, which has a spiral section prolonged spirally in an axial direction, and (ii) an inner element, which has a spiral section prolonged spirally in the axial direction and is surrounded, with an interval space, by the outer element, one of the two elements being a signal line, an other of the two elements being a GND line; and
a support member including a dielectric member and contacting each of the spiral sections of the outer and inner elements while supporting the outer and inner elements in a predetermined positional relationship,
wherein a number of turns of the spiral section in the inner element is equal to or less than a number of turns of the spiral section in the outer element.

2. The antenna apparatus according to claim 1, wherein
the spiral section of the inner element is covered by the support member while the spiral section of the outer element winds around an external surface of the support member.

3. The antenna apparatus according to claim 2, wherein:
in the axial direction of the spiral sections, lengths of the two elements are approximately equal to each other; and
the support member intervenes between the spiral section of the outer element and the spiral section of the inner element in a range where the two spiral sections face each other.

4. The antenna apparatus according to claim 1, further comprising:
a substrate having a surface on which two lands are respectively provided to be coupled with a high frequency wave source,
wherein:
the axial direction of the spiral sections in the two elements is approximately parallel with the surface of the substrate forming the two lands; and
the two elements have terminal ends, respectively, at a same end portion along the axial direction, the respective terminal ends of the two elements being coupled with the different lands, respectively.

5. The antenna apparatus according to claim 1, further comprising:
a substrate having a surface on which two lands are respectively provided to be coupled with a high frequency wave source,
wherein:
the axial direction of the spiral sections in the two elements is approximately orthogonal to the surface of the substrate forming the two lands; and
the two elements have terminal ends: respectively, at a same end portion along the axial direction, the respective terminal ends of the two elements being coupled with the different lands, respectively.

6. The antenna apparatus according to claim 5, wherein:
one of the two lands is electrically coupled with a GND pattern formed on the surface forming the lands in the substrate; and
joint members joining the terminal ends of the elements to the spiral sections are laminated above the GND pattern via the support member to thereby form a strip line structure.

7. The antenna apparatus according to claim 1, wherein
the support member is provided inside of the spiral section of the inner element while contacting the inner element.

8. The antenna apparatus according to claim 1, wherein
the support member is provided outside of the spiral section of the outer element while contacting the outer element.
